(19) United States
(12) Patent Application Publication
(10) Pub. No.: US 2012/0187662 A1
(43) Pub. Date: Jul. 26, 2012

(54) APPARATUS FOR TRANSPORTING LOADS

(75) Inventor: Martin Philip Riddiford, Greater London (GB)

(73) Assignee: FILLABALL HOLDINGS LIMITED, Smarden (GB)

(21) Appl. No.: 13/496,439

(22) PCT Filed: Sep. 15, 2010
(86) PCT No.: PCT/GB10/51550

§ 371 Date: Apr. 11, 2012

(30) Foreign Application Priority Data
Sep. 15, 2009 (GB) 0916168.8
Sep. 15, 2010 (GB) PCT/GB2010/051550

(51) Int. Cl. B62B 3/02

(52) U.S. Cl. 280/652

(57) ABSTRACT

Carriers for loads are disclosed, especially beach use, e.g. as beach carriers or for transporting kayaks or canoes. A foldable assembly of two elongate members (1, 2) forms a frame, the two members being pivotally connected at one end (3), and their other ends carrying wheels (10, 11). A support strap (6) or foldable support between the elongate members, and the members themselves, forms a stable base for the load, and the wheels (10, 11) enable it to be pushed or pulled along. Preferably the wheels (10, 11) are hemispherical with their axes of rotation inclined downwardly and outwardly with respect to the elongate load.

This invention relates to apparatus for transporting loads in particular over rough or soft terrain, such as a beach.

Numerous such apparatus are known, generally consisting of some sort of frame structure which has at least one pair of ground-engaging wheels and which is adapted to support the load to be transported. When the load is relatively compact, a simple trolley or cart structure is often adopted. In the case of longer loads, for example a canoe or kayak, it is conventional to provide a support frame with wheels which is much shorter than the object itself. The frame is located under the centre of gravity of the object, or in the vicinity thereof, and serves to support the longer load as it is pulled or pushed along from one end, i.e. the user does not actually grasp the apparatus itself.

Because such apparatus is often used to transport a load over rough terrain, and/or over ground that is not firm, for example sand or shingle, the ground-engaging wheels are usually of substantial width so they do not sink into the surface as the apparatus and its load are moved, and the wheels are usually spaced well apart, e.g. by at least the width of a canoe or kayak in the case of a carrier adapted to bear such a load.

It is also desirable that any such apparatus for transporting loads is either itself compact, or can be folded or collapsed to a relatively compact form so as to enable its easy stowage when not in use. This is of particular concern in the case of apparatus used for transporting a canoe or kayak overland, since the user of the canoe or kayak usually wishes to take it with them when the canoe or kayak is in the water, both to avoid the risk of its removal from the water's edge while the user is afloat and to ensure that it is to hand when landing, very often not necessarily at the same place from which the canoe or kayak was launched.

We have now found that by appropriate construction, load-carrying apparatus suitable for rough and/or soft terrain may be provided which avoids many of the disadvantages associated with previously known beach and all terrain carriers as well as kayak and canoe carriers.

According to the present invention there is provided an apparatus for transporting a load which consists of a frame including two elongate rigid members pivotally connected to one another at or near one end, each member carrying a wheel rotatably mounted thereon, and a flexible or foldable load support member linking the two rigid members and connected to each member at a point remote from the pivotal connection and from the wheel mounting.

The pivotal connection enables the apparatus to be collapsed so that the elongate members lie adjacent to one another and by suitable dimensioning the collapsed unit can be stowed in a compartment inside the kayak. When the apparatus is to be put to use, the members are splayed apart, the maximum distance being determined by the length of the flexible support member, which may be adjustable to enable use with different loads, and located adjacent the kayak. The kayak is then moved to bring its centre (roughly—it can be fore or aft of the centre without causing problems) to a position above the apparatus and then lowered on to it until its lower surface comes to rest on the flexible support member and against parts of the elongated rigid members. The wheels of the apparatus remain resting on the ground during loading, as does one end of the kayak if the loading is being carried out (as is often the case) by one person. If desired, one or more strap may be passed round the top of the kayak to hold the body of the kayak against the apparatus and stop any slippage during transport. Then, by lifting the end of the kayak resting on the ground, it comes to be supported entirely by the apparatus, and the assembly of apparatus and kayak can then be pushed or pulled along, usually simply by pulling or pushing one end of the kayak itself, though if desired the apparatus may be pulled along by a suitable length leash attached at one end near the pivotal connection of the two elongate members.

The wheels are preferably of substantially hemispherical shape, with their axes of rotation non-horizontal. Such arrangements of wheels for travelling over rough terrain have been previously proposed, for example as shown in WO 2009/098641 and GB 757663. The use of wheels of hemispherical shape mounted on separate axles, each inclined to the horizontal, and inclined to one another by 70 to 110 degrees, enables a load carrying apparatus to be designed which is easy to manoeuvre and which gives good clearance between the wheels (the normal horizontal common axle is avoided) so assisting transport over rough ground.

The wheels are preferably arranged so that when the apparatus is seen from the side, they lie between the pivotal connection and the flexible support member, and below a line between the flexible support member and the pivotal connection.

A particularly preferred way of achieving this which is elegant and light in weight is to provide that each elongate member extends forward from the pivotal connection, past the connection point to the flexible support member, and then bends downward through more than 90 degrees and extends rearwardly until its end lies between, and lower than, the pivotal connection and the flexible support member. At the end of each elongate member there is a stub axle on which the wheel is mounted.

The wheels may be mounted on the stub axles in freely rotatable fashion, but it is sometimes desirable to mount them in such a way that they may rotate freely in one sense but, in the other sense, being wholly or partially braked. This is useful as enabling the loaded apparatus to be effectively automatically braked by orienting it and its load on a slope such as a beach so that it will not roll easily (or at all) down the slope, but can easily be pushed or pulled up it. Known spring clutch or freewheel mechanisms may be used to effect this, for example by incorporating such mechanisms between a hub designed to be fixed in non-rotary fashion to the stub axles and a wheel portion rotatable on the hub. A lever on the wheel or hub portion may be moved between ‘fixed’ (i.e. braked), ‘partly braked’ and ‘free’ positions.

If desired, in order to enable even easier and more compact stowage of the apparatus, the wheels may be fixed to the elongate rigid members by releasable couplings, enabling them to be dismounted for stowage.

The pivotal connection may be constructed in any convenient fashion, but a preferred pivotal connection is one made by angling the ends of the elongate members and mounting both angled ends in side-by-side parallel cylindrical bores in a joint member, for example two short pieces of tube welded side by side. The pivotal connection may be permanent or demountable in order to facilitate storage of the apparatus when not in use.

In a particularly preferred embodiment of the invention, the support member is foldable to allow the elongate rigid members to approach one another and the wheels are mounted on the elongate rigid members via the foldable support member so that, as the support member is folded, the wheels come together.

Although described below are two types of load carrier in accordance with the invention, each with two wheels, it is possible, e.g. for heavy and/or very elongate loads, to use two such apparatus either spaced apart under an elongate load or coupled together to form a four-wheel load-carrying apparatus.

The invention is illustrated by way of example with reference to the accompanying drawings in which:

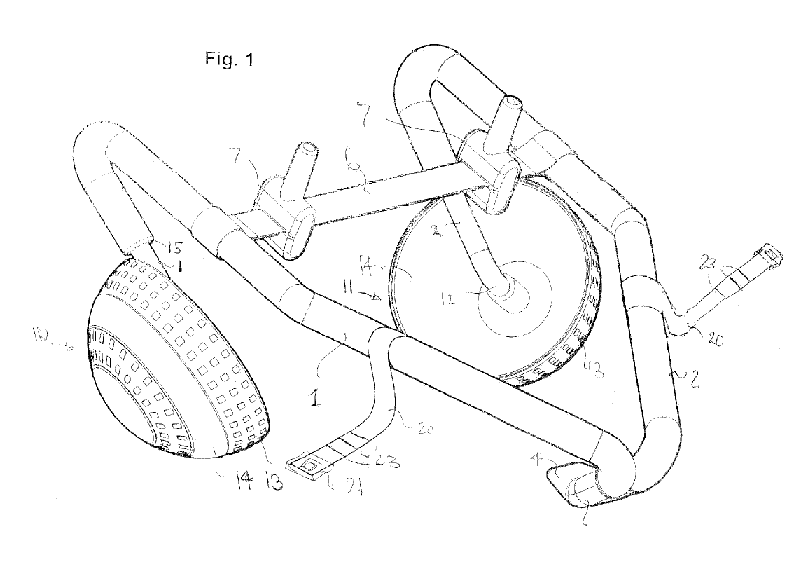

FIG. 1 is a perspective view of kayak carrier apparatus according to the present invention ready for loading;

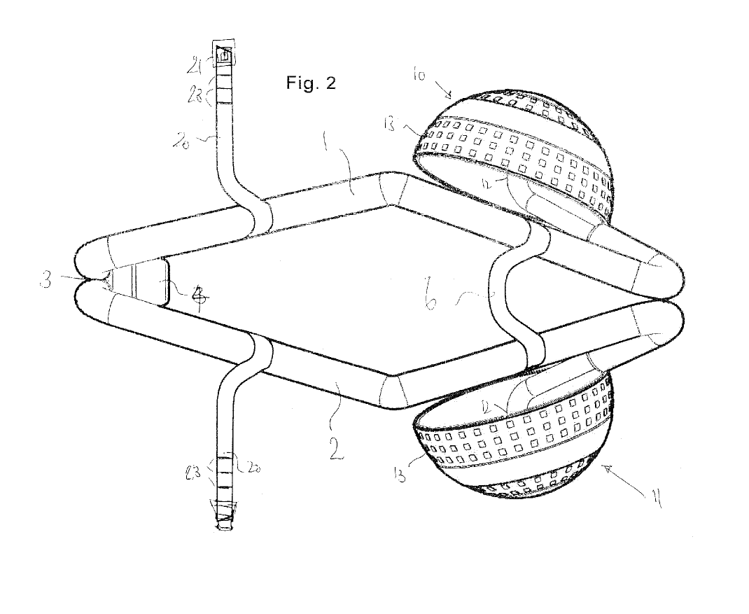

FIG. 2 is a diagram of the apparatus of FIG. 1 folded for stowage;

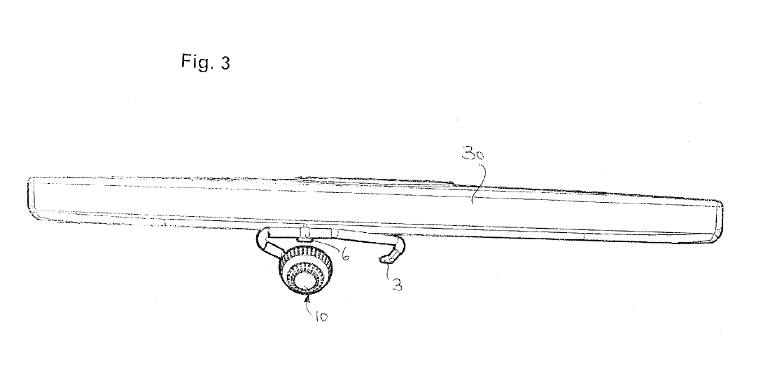

FIG. 3 is a side view of a kayak supported on the apparatus of FIG. 1;

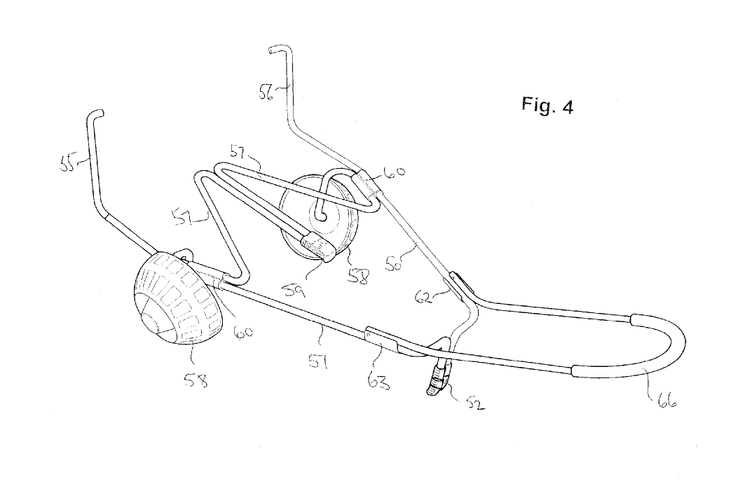

FIG. 4 is a perspective view of the frame of a load-carrying apparatus according to the invention, seen as in use to support a load;

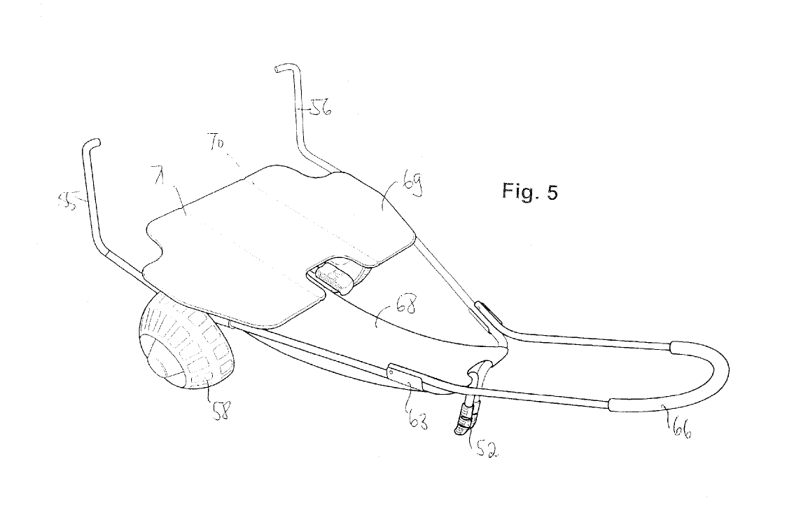

FIG. 5 is a perspective view of the frame shown in FIG. 4 and showing load-carrying components mounted thereon;

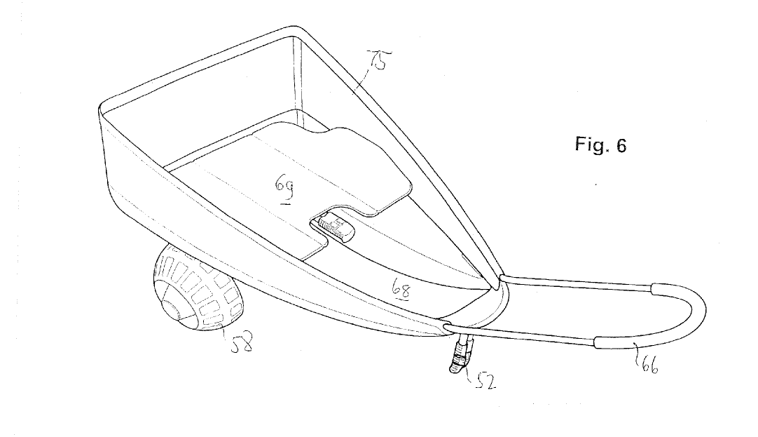

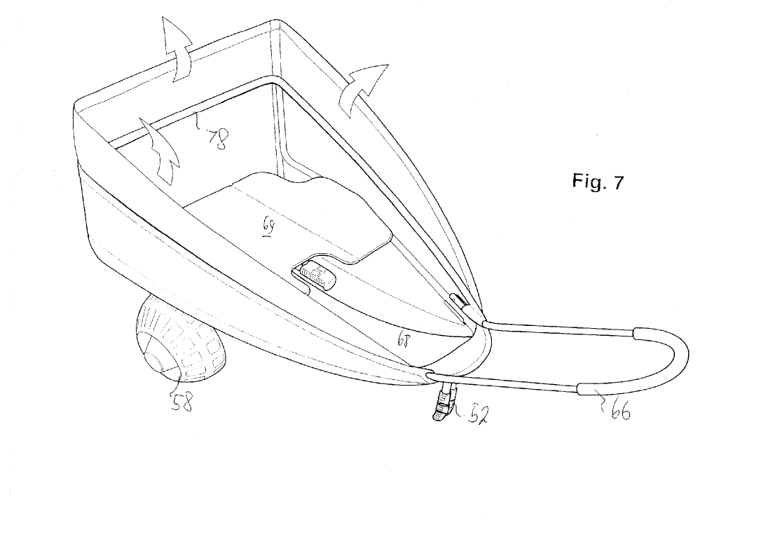

FIGS. 6 and 7 are perspective views of the frame shown in FIG. 5 and carrying sidewalls respectively in folded half height and full height;

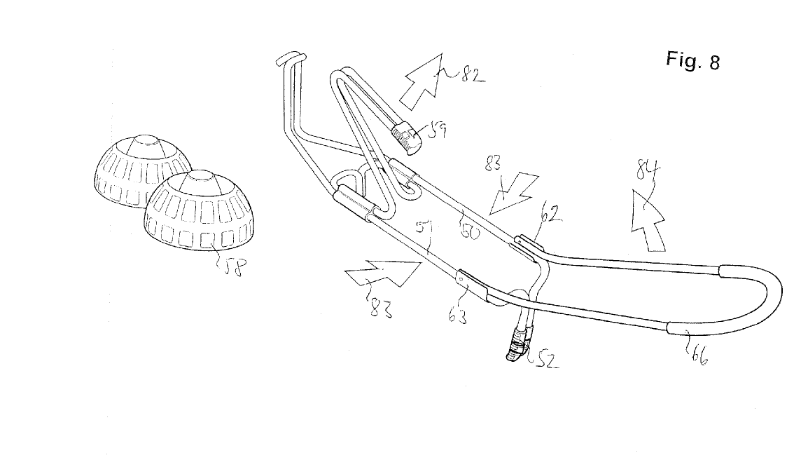

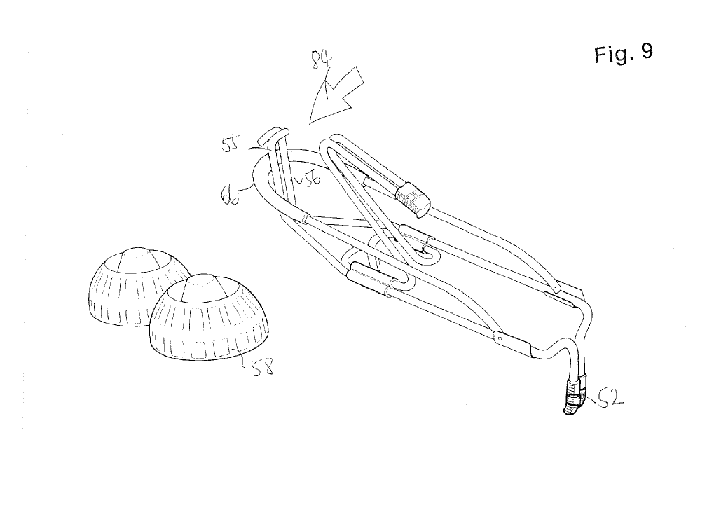

FIGS. 8 and 9 are perspective views of the frame of the load-carrying apparatus according to the invention shown in FIGS. 4 to 7 respectively in part folded and completely folded positions; and

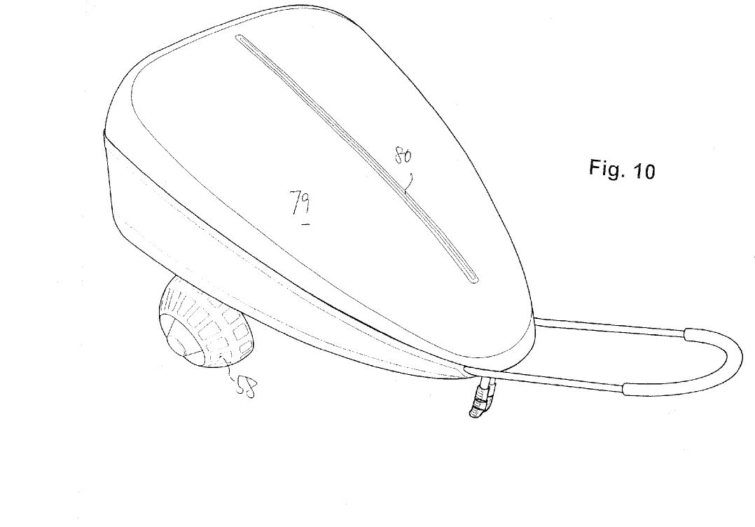

FIG. 10 is a perspective view of a beach cart using the frame as shown in FIG. 4.

Referring to FIGS. 1 to 3, the apparatus consists of two elongate tubes 1, 2, shaped as shown. At the right hand end as seen in the drawings, the end of each of tubes 1 and 2 is pivotally supported in a downwardly pointing handle 3, which has two parallel cylindrical bores each receiving a post fixed to the end of the tube 1, 2. Handle 3 has a rubbery grippable cover 4.

A flexible support strap 6 is attached at each of its ends to tubes 1 and 2. As shown in FIG. 1, strap 6 carries a pair of rubber mouldings 7 which have a vertically projecting finger adapted to engage in a corresponding socket in the kayak in order to assist in holding a kayak in place. Other configurations of such mouldings may be used to engage with alternative formations on the kayak, for example grooves.

The ends of tubes 1 and 2 are bent down through around 135 degrees and carry a wheel 10, 11 at their respective lower ends. The wheels 10, 11 are mounted on stub axles 12 inclined towards the ground. The angle between the axes of the two stub axles is around 90 degrees. Each wheel is substantially hemispherical. The outside of the wheel may carry a treaded face 13, for example of a rubbery material overmoulded on to a hard plastics shell 14.

The exterior of the elongate members 1, 2 is covered with a resilient dense foam 15 which enables a firm fit of the kayak to be achieved, as this compresses when the kayak is placed on top of the apparatus.

The kayak may be held on to the apparatus by means of a strap 20 attached to members 1,2, and including a releasable buckle 21 and length adjuster means 22 of known design. Each strap 20 bears markings 23 set at equal distances from where strap 20 is attached to members 1, 2, so that, when laid on the ground as shown in FIGS. 1 and 2, they are visible to the user of the apparatus as a kayak is placed on it, so that, despite not being able to see the apparatus, the user can centre the kayak laterally on the apparatus.

The loading of a kayak 30 on to the apparatus is simple. It is unfolded by pulling members 1 and 2 apart and laid on the ground in the position shown in FIG. 1. In this position, with handle 3 resting on the ground, the plane containing the two stub axles is not perpendicular to the ground, so the two wheels exert a braking effect on the apparatus, so it tends not to move or roll very easily (this effect is explained in more detail in WO 2009/098641). The kayak is then laid on top of it and, because of the relative location of the strap 6 and wheels 10, 11, the handle 3 is lifted off the ground and the apparatus ‘self-levels’ underneath the kayak, as shown in FIG. 3, rendering the plane containing the stub axles 12 vertical, so it can now roll freely. Thus the kayak 30 is supported on the ground with good clearance, especially as there is no horizontal axle between the two wheels. This and the vertical plane of the stub axles 12 makes moving it along easier.

The collapsed or folded configuration of the apparatus, as shown in FIG. 2, enables it to be stowed in a relatively small space when not in use. In particular, it may fit inside the kayak when it is on the water. If the kayak design is such that interior space is very limited, it is possible to construct the apparatus so that the pivotal connection may be dismounted to enable the apparatus to take up even less room. The wheels may be dismountable for a similar purpose. If the elongate members are hollow tubes, sealed at their ends, and/or if foam 15 is closed cell foam, the overall density of the apparatus may be less than that of water, i.e. the apparatus will float, which can be helpful if the user wishes to position the apparatus underneath a kayak floating on the water, or if the user launches the kayak by pushing it on the apparatus into the sea and then detaches it from the then floating kayak.

Referring now to FIGS. 4 to 10, FIG. 4 shows the frame of a load carrier in its deployed state, i.e. with its component parts positioned as if the load carrier was in use. For clarity, just the framework is shown, without any load-carrying compartment, basket or the like. The frame consists of a pair of elongate members 50, 51 pivoted together in a common handle 52 and extending to the left from their pivotal connection as shown in FIG. 4. Their ends remote from the pivotal connection are upturned to provide two carrier posts 55, 56 for a structure to be fitted on to the frame, as described below. The handle 52 which enables members 51, 52 to be pivoted together, is effectively a twin sleeve hinge member, and it also acts as a forward strut base to support the frame of the carrier apparatus on the ground.

Between members 50, 51 is a pair of tubular members 57, each of which carries at one end a hemispherical wheel 58, and which are connected pivotally together at their other ends by a twin sleeve hinge member 59. Intermediate its ends, each member 57 has a section running adjacent and parallel to respective members 50, 51 and hinged thereto by a double-sleeved joint member 60.

Near the right hand ends of members 50 and 51 as seen in FIG. 4 are two fixed mounting plates 62, 63. A hoop-shaped handle 66 is pivotally connected at its ends to plates 62, 63, enabling it to be swivelled from the position shown in FIG. 4, in which it extends to the right of members 50, 51, to one in which it overlies them.

FIG. 5 shows the frame illustrated in FIG. 4 and fitted with a floor portion 69 and an underlying flexible slung carrier 68. Floor section 69 is in the form of three sections with the outer sections being foldable along fold lines 70 and 71 relative to the central section. The apparatus of FIG. 5 can accordingly carry loads on floor 69 and support 68 and is pulled along by handle 66.

FIG. 6 shows the addition to the apparatus of an outer wall section 75 which fits on to carrier posts 55, 56 and an internal hoop member of which clips on to the hoop-shaped handle 66 adjacent plates 62 and 63. This is shown more clearly in FIG. 7 where the hoop is denoted 78 and, as can be seen in FIG. 7, part of the outer wall 75, which is as shown in FIG. 6 folded downwardly from hoop 78, may be folded up and out as shown by the arrows to increase the overall height of the compartment available for carrying items in the apparatus.

If desired, the items being carried may be covered with a cover 79, for example attached by means of a sliding clasp fastener system to the top of wall 75. The cover 79 may be rigid or floppy and may have a central opening 80 which may be closed or opened by means of a sliding clasp fastener.

FIGS. 8 and 9 show how the frame of the carrier apparatus may be collapsed for storage or, for example, for transportation in the boot or trunk of a vehicle. First of all, the wheels 58 are detached by means of any convenient mechanism, and the handle 59 then pulled upwards. This is indicated by arrow 82 in FIG. 8. This causes the two elongate members 50 and 51 to approach one another as shown by arrows 83 swivelling in handle 52. Handle 66 is then moved as shown by arrow 84 with its ends pivoting in the plates 62 and 63 and is swung over the top of members 57 and comes to lie with its end surrounding the now-adjacent posts 55 and 56. The final folded configuration is as shown in FIG. 9.

1. Apparatus for transporting a load which consists of a frame including two elongate rigid members pivotally connected to one another at or near one end, each member carrying a wheel rotatably mounted thereon, and a flexible or foldable support member linking the two rigid members and connected to each member at a point remote from the pivotal connection and from the wheel mounting.

2. Apparatus according to claim 1 wherein the wheels are of substantially hemispherical shape, with their axes of rotation non- horizontal.

3. Apparatus according to claim 1 and including one or more adjustable strap means adapted to encircle a load and to hold the load against parts of the rigid members and the flexible or foldable support member.

4. Apparatus according to claim 3 wherein the strap means includes a pair of straps each attached at one end to one of the elongate rigid members and bearing one or more visible markings towards their free ends, the distance from the marking(s) to the rigid member being the same for each strap.

5. Apparatus according to claim 1 wherein the pivotal connection is in the form of a downwardly directed handle in which one or both elongate rigid members may rotate.

6. Apparatus according to claim 1 wherein the support member may be flexed or folded to allow the elongate rigid members to approach one another and the wheels are mounted on the elongate rigid members via the flowable support member so that, as the support member is flexed or folded, the wheels come together.

7. Apparatus according to claim 6 and including a U-shaped towing handle, the ends of the U-shape being pivotally connected to the elongate rigid members near their connection to one another.

8. Apparatus according to claim 7 wherein the pivotal connection enables the handle to be folded over to lie partially above the wheel mountings.

9. Apparatus according to claim 1 and including a resilient covering over those parts of the elongate members which would otherwise come into contact with a load placed thereon.
